(19) United States
(12) Patent Application Publication
(10) Pub. No.: US 2017/0160712 A1
(43) Pub. Date: Jun. 8, 2017

(54) ELECTRONIC DEVICE FOR CONTROLLING EXTERNAL ELECTRONIC DEVICE AND OPERATING METHOD THEREOF

(71) Applicant: Samsung Electronics Co., Ltd., Gyeonggi-do (KR)

(72) Inventor: June-Hee YUN, Gyeonggi-do (KR)

(21) Appl. No.: 15/366,749

(22) Filed: Dec. 1, 2016

(30) Foreign Application Priority Data
Dec. 3, 2015 (KR) 10-2015-0171551

(51) Int. Cl. G05B 19/042; G06T 11/60; G08C 23/04

(52) U.S. Cl. CPC G05B 19/042; G08C 23/04; G06T 11/60; G05B 2219/23153

(57) ABSTRACT

An electronic device for controlling external electronic devices and an operating method thereof are provided. The electronic device includes an output device, and a processor configured to create pattern information corresponding to control information for one or more external electronic devices and provide the pattern information to the outside of the electronic device through the output device to control the one or more external electronic devices.

### PRIORITY

This application claims priority under 35 U.S.C. §119(a) to Korean Patent Application Serial No. 10-2015-0171551, which was filed in the Korean Intellectual Property Office on Dec. 3, 2015, the entire content of which is incorporated herein by reference.

### BACKGROUND

1. Field of the Disclosure

The present disclosure generally relates to a method and apparatus for controlling external electronic devices and more particularly, to an electronic device for controlling external electronic devices by using pattern information.

2. Description of the Related Art

Due to the development of information and communication technology and semiconductor technology, use of portable electronic devices is rapidly growing, and the portable electronic devices have become necessities for users. Such electronic devices provide a variety of functions that are required by users. For example, the electronic devices provide various functions, such as mobile communication, short-range wireless communication, broadcast receiving, and Internet access.

Recently, a technique has been developed, in which an electronic device controls external electronic devices by using a wireless connection and remote control.

An electronic device located indoors may not be able to determine the position of the external electronic device because the exact position thereof (for example, area separation) is not recognized based on the GPS (global positioning system) signal, which may be difficult to receive indoors.

### SUMMARY

An aspect of the present disclosure provides an electronic device and a method in which the electronic device may create pattern information to change the movement and state of the external electronic device in order to control the external electronic device.

According to another aspect of the present disclosure, an electronic device is provided which includes an output device and a processor, wherein the processor is configured to create pattern information corresponding to control information for one or more external electronic devices and is configured to provide the pattern information to the outside of the electronic device through the output device in order to control the one or more external electronic devices.

According to another aspect of the present disclosure, an external electronic device is provided which includes an input device and a processor, wherein the processor is configured to obtain pattern information corresponding to control information for the electronic device using the input device and is configured to control the electronic device based on the pattern information.

According to another aspect of the present disclosure, an operating method of an electronic device is provided for controlling external electronic devices, which includes an output device and a processor. The method includes creating pattern information corresponding to control information for one or more external electronic devices using the processor and providing the pattern information to the outside of the electronic device using the output device in order to control the one or more external electronic devices.

According to another aspect of the present disclosure, an operating method of an external electronic device is provided that includes an input device and a processor. The method includes obtaining pattern information corresponding to control information for the electronic device using the input device and controlling the electronic device based on the pattern information using the processor.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 illustrates a network environment including an electronic device, according to an embodiment of the present disclosure;

FIG. 2 is a block diagram of an electronic device, according to an embodiment of the present disclosure;

FIG. 3 is a block diagram of a program module, according to an embodiment of the present disclosure;

FIG. 4 is illustrates a system in which an electronic device controls an external electronic device, according to an embodiment of the present disclosure;

FIG. 5 is a block diagram of an electronic device, according to another embodiment of the present disclosure;

FIG. 6 is a block diagram of an external electronic device, according to an embodiment of the present disclosure;

FIG. 7 is a flow diagram of an operation of an electronic device and an external electronic device, according to an embodiment of the present disclosure;

FIG. 8 is a flowchart of a method of an electronic device, according to an embodiment of the present disclosure;

FIG. 9 is a flowchart of a method for creating a pattern in an electronic device, according to an embodiment of the present disclosure;

FIGS. 10A and 10B illustrate instructions that are allocated to figures and characters that are used in an electronic device when creating pattern information, according to an embodiment of the present disclosure;

FIGS. 11A and 11B illustrate pattern information that is provided by an electronic device, according to an embodiment of the present disclosure;

FIG. 12 is a flowchart of a method of an external electronic device, according to another embodiment of the present disclosure;

FIG. 13 is a flowchart of a method for identifying a pattern in an external electronic device, according to an embodiment of the present disclosure;

FIG. 14 is a flowchart of a method for performing movement control in an external electronic device, according to an embodiment of the present disclosure;

FIG. 15 illustrates a method for finding a reference point in the pattern information, according to an embodiment of the present disclosure;

FIGS. 16A and 16B illustrate a method for finding a reference point in the pattern information, according to another embodiment of the present disclosure;

FIGS. 17A and 17B illustrate a method for finding a reference point in the pattern information, according to another embodiment of the present disclosure; and

FIG. 18 illustrates a system in which an electronic device controls an external electronic device by using another external electronic device, according to an embodiment of the present disclosure.

### DETAILED DESCRIPTION

Hereinafter, various embodiments of the present disclosure will be described with reference to the accompanying drawings. However, it should be understood that there is no limiting the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, singular forms may include plural forms as well unless the context clearly indicates otherwise. The expressions “have”, “may have”, “include”, or “may include” refer to the existence of a corresponding feature (e.g., numeral, function, operation, or constituent element such as component), and do not exclude one or more additional features.

In the present disclosure, the expressions “A or B”, “at least one of A or/and B”, or “one or more of A or/and B” may include all possible combinations of the items listed.

The expressions “a first”, “a second”, “the first”, or “the second” used in various embodiments of the present disclosure may modify various components regardless of the order and/or the importance but do not limit the corresponding components.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposed between them.

The expression “configured to” as used in the present disclosure may be used interchangeably with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a general-purpose processor (e.g., central processing unit (CPU) or application processor (AP)) that may perform the corresponding operations by executing one or more software programs stored in a memory device.

An electronic device according to an embodiment of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), an MPEG-1 audio layer-3 (MP3) player, a mobile medical device, a camera, and a wearable device. The wearable device may include at least one of an accessory type (e.g., a watch, a ring, a bracelet, an anklet, a necklace, eyeglasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

According to an embodiment of the present disclosure, the electronic device may be a home appliance. The home appliance may include at least one of, for example, a television, a digital video disk (DVD) player, an audio player, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to an embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, an electronic device for a ship (e.g., a navigation device for a ship, and a gyro-compass), avionics, security devices, an automotive head unit, a robot for home or industry, an automatic teller machine (ATM), point of sales (POS) terminal, or Internet of things (IoT) device (e.g., a light bulb, various sensors, electric or gas meter, a sprinkler device, a fire alarm, a thermostat, a streetlamp, a toaster, sporting goods, a hot water tank, a heater, a boiler, etc.).

According to an embodiment of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device may be a combination of one or more of the aforementioned various devices. The electronic device may be a flexible device. Further, the electronic device is not limited to the aforementioned devices, and may include a new electronic device according to the development of technology.

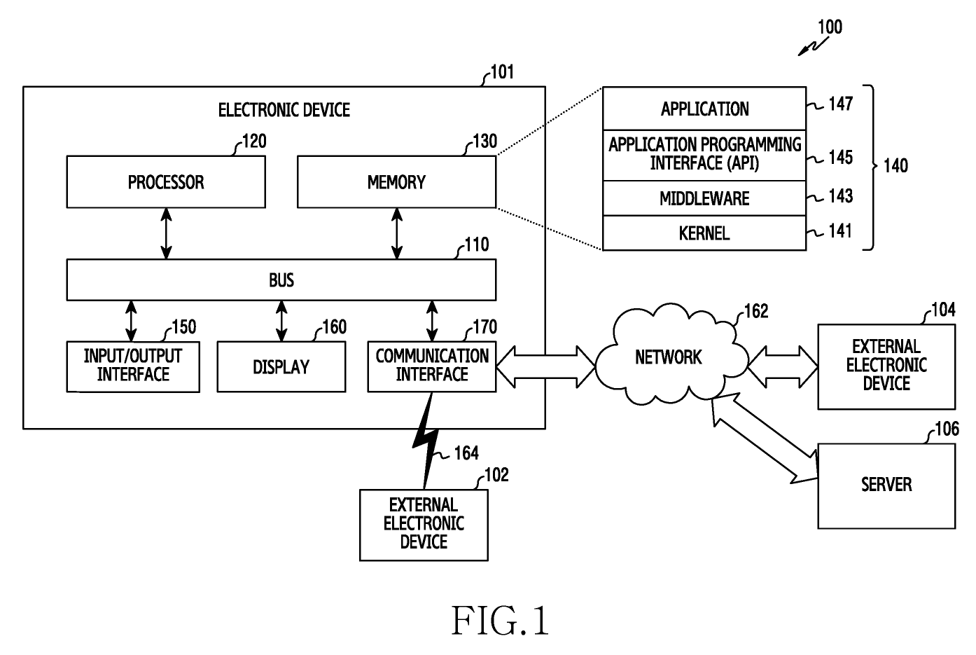

FIG. 1 illustrates a network environment including an electronic device according to an embodiment of the present disclosure.

An electronic device 101 within a network environment 100, will be described with reference to FIG. 1. The electronic device 101 includes a bus 110, a processor 120, a memory 130, an input/output interface 150, a display 160, and a communication interface 170. According to an embodiment of the present disclosure, the electronic device 101 may omit at least one of the above components or may further include other components.

The bus 110 may include, for example, a circuit which interconnects the components 110 to 170 and delivers a communication (e.g., a control message and/or data) between the components 110 to 170.

The processor 120 may include one or more of a central processing unit (CPU), an application processor (AP), and a communication processor (CP). The processor 120 may carry out, for example, calculation or data processing relating to control and/or communication of at least one other component of the electronic device 101.

The memory 130 may include a volatile memory and/or a non-volatile memory. The memory 130 may store, for example, commands or data relevant to at least one other component of the electronic device 101. According to an embodiment of the present disclosure, the memory 130 may store software and/or a program 140. The program 140 includes, for example, a kernel 141, middleware 143, an application programming interface (API) 145, and/or application programs (or “applications”) 147. At least some of the kernel 141, the middleware 143, and the API 145 may be referred to as an operating system (OS).

The kernel 141 may control or manage system resources (e.g., the bus 110, the processor 120, or the memory 130) used for performing an operation or function implemented in the other programs (e.g., the middleware 143, the API 145, or the application programs 147). Furthermore, the kernel 141 may provide an interface through which the middleware 143, the API 145, or the application programs 147 may access the individual components of the electronic device 101 to control or manage the system resources.

The middleware 143, for example, may serve as an intermediary for allowing the API 145 or the application programs 147 to communicate with the kernel 141 to exchange data.

Also, the middleware 143 may process one or more task requests received from the application programs 147 according to priorities thereof. For example, the middleware 143 may assign priorities for using the system resources (e.g., the bus 110, the processor 120, the memory 130, and the like) of the electronic device 101, to at least one of the application programs 147. For example, the middleware 143 may perform scheduling or loading balancing on the one or more task requests by processing the one or more task requests according to the priorities assigned thereto.

The API 145 is an interface through which the applications 147 control functions provided from the kernel 141 or the middleware 143, and may include, for example, at least one interface or function (e.g., instruction) for file control, window control, image processing, character control, and the like.

The input/output interface 150, for example, may function as an interface that may transfer commands or data input from a user or another external device to the other element(s) of the electronic device 101. Furthermore, the input/output interface 150 may output the commands or data received from the other element(s) of the electronic device 101 to the user or another external device.

Examples of the display 160 may include a liquid crystal display (LCD), a light-emitting diode (LED) display, an organic light-emitting diode (OLED) display, a microelectromechanical systems (MEMS) display, and an electronic paper display. The display 160 may display, for example, various types of content (e.g., text, images, videos, icons, or symbols) to users. The display 160 may include a touch screen, and may receive, for example, a touch, gesture, proximity, or hovering input using an electronic pen or a user's body part.

The communication interface 170 may establish communication, for example, between the electronic device 101 and a first external electronic device 102, a second external electronic device 104, or a server 106. For example, the communication interface 170 may be connected to a network 162 through wireless or wired communication, and may communicate with the second external electronic device 104 or the server 106.

The wireless communication may use at least one of, for example, long term evolution (LTE), LTE-Advance (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include, for example, short range communication 164. The short-range communication 164 may include at least one of, for example, Wi-Fi, Bluetooth, near field communication (NFC), and global navigation satellite system (GNSS). GNSS may include, for example, at least one of global positioning system (GPS), global navigation satellite system (Glonass), Beidou navigation satellite system (Beidou) or Galileo, and the European global satellite-based navigation system, based on a location, a bandwidth, and the like. Hereinafter, in the present disclosure, the term “GPS” may be interchangeably used with the term “GNSS”. The wired communication may include, for example, at least one of a universal serial bus (USB), a high definition multimedia interface (HDMI), recommended standard 232 (RS-232), and a plain old telephone service (POTS). The network 162 may include at least one of a telecommunication network such as a computer network (e.g., a LAN or a WAN), the Internet, and a telephone network.

Each of the first and second external electronic devices 102 and 104 may be of a type identical to or different from that of the electronic device 101. According to an embodiment of the present disclosure, the server 106 may include a group of one or more servers. All or some of the operations performed in the electronic device 101 may be executed in another electronic device the electronic devices 102 and 104 or the server 106. When the electronic device 101 has to perform some functions or services automatically or in response to a request, the electronic device 101 may request the electronic device 102 or 104 or the server 106 to execute at least some functions relating thereto instead of or in addition to autonomously performing the functions or services. The electronic device 102 or 104, or the server 106 may execute the requested functions or the additional functions, and may deliver a result of the execution to the electronic device 101. The electronic device 101 may process the received result as it is or additionally, and may provide the requested functions or services. To this end, for example, cloud computing, distributed computing, or client-server computing technologies may be used.

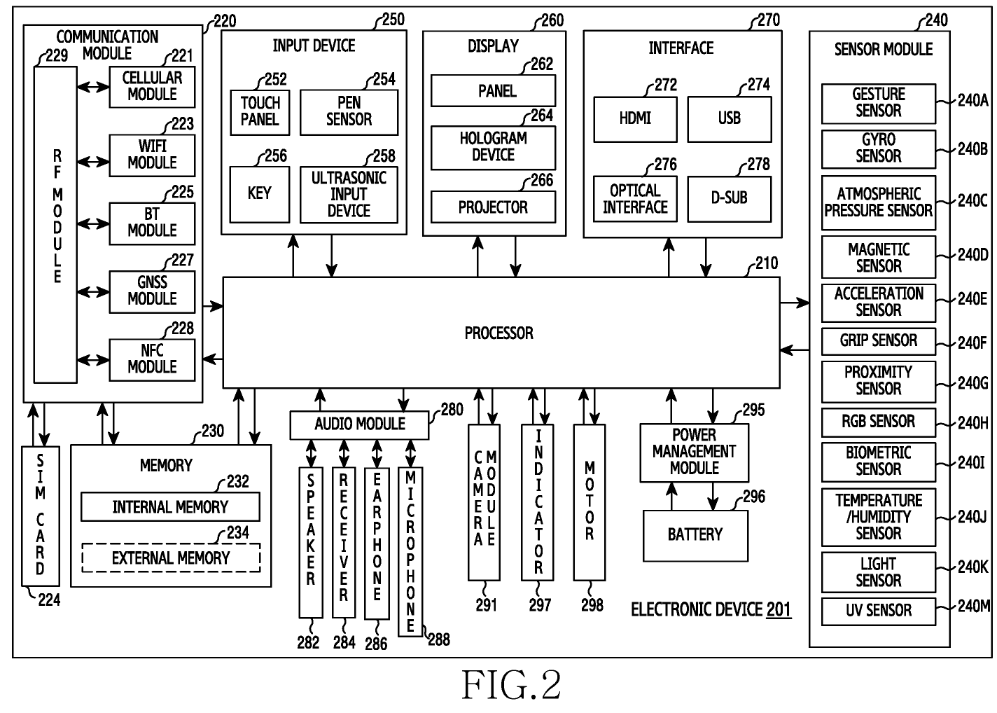

FIG. 2 is a block diagram of an electronic device according to an embodiment of the present disclosure. The electronic device 201 may include, for example, all or a part of the electronic device 101 shown in FIG. 1. The electronic device 201 includes one or more processors 210 (e.g., application processors (AP)), a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program, and perform processing of various pieces of data and calculations. The processor 210 may be embodied as, for example, a system on chip (SoC). According to an embodiment of the present disclosure, the processor 210 may further include a graphic processing unit (GPU) and/or an image signal processor. The processor 210 may include at least some (for example, a cellular module 221) of the components illustrated in FIG. 2. The processor 210 may load, into a volatile memory, commands or data received from at least one (e.g., a non-volatile memory) of the other components and may process the loaded commands or data, and may store various data in a non-volatile memory.

The communication module 220 may have a configuration equal or similar to that of the communication interface 170 of FIG. 1. The communication module 220 includes, for example, a cellular module 221, a Wi-Fi module 223, a BT module 225, a GNSS module 227 (e.g., a GPS module 227, a Glonass module, a Beidou module, or a Galileo module), an NFC module 228, and a radio frequency (RF) module 229.

The cellular module 221, for example, may provide a voice call, a video call, a text message service, or an Internet service through a communication network. According to an embodiment of the present disclosure, the cellular module 221 may distinguish and authenticate the electronic device 201 in a communication network using the subscriber identification module 224 (for example, the SIM card). The cellular module 221 may perform at least some of the functions that the AP 210 may provide. The cellular module 221 may include a communication processor (CP).

For example, each of the Wi-Fi module 223, the BT module 225, the GNSS module 227, and the NFC module 228 may include a processor for processing data transmitted/received through a corresponding module. According to an embodiment of the present disclosure, at least some (e.g., two or more) of the cellular module 221, the Wi-Fi module 223, the BT module 225, the GNSS module 227, and the NFC module 228 may be included in one integrated chip (IC) or IC package.

The RF module 229, for example, may transmit/receive a communication signal (e.g., an RF signal). The RF module 229 may include, for example, a transceiver, a power amplifier module (PAM), a frequency filter, a low noise amplifier (LNA), and an antenna. According to an embodiment of the present disclosure, at least one of the cellular module 221, the WIFI module 223, the BT module 225, the GNSS module 227, and the NFC module 228 may transmit/receive an RF signal through a separate RF module.

The subscriber identification module 224 may include, for example, a card including a subscriber identity module and/or an embedded SIM, and may contain unique identification information (e.g., an integrated circuit card identifier (ICCID)) or subscriber information (e.g., an international mobile subscriber identity (IMSI)).

The memory 230 (e.g., the memory 130) includes, for example, an embedded memory 232 or an external memory 234. The embedded memory 232 may include at least one of a volatile memory (e.g., a dynamic random access memory (DRAM), a static RAM (SRAM), a synchronous dynamic RAM (SDRAM), and the like) and a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), a hard disc drive, a solid state drive (SSD), and the like).

The external memory 234 may further include a flash drive, for example, a compact flash (CF), a secure digital (SD), a micro secure digital (Micro-SD), a mini secure digital (Mini-SD), an eXtreme digital (xD), a multimediacard (MMC), a memory stick, and the like. The external memory 234 may be functionally and/or physically connected to the electronic device 201 through various interfaces. The sensor module 240, for example, may measure a physical quantity or detect an operation state of the electronic device 201, and may convert the measured or detected information into an electrical signal. The sensor module 240 includes, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue (RGB) sensor), a biometric sensor (medical sensor) 2401, a temperature/humidity sensor 240J, an illuminance sensor 240K, and a ultra violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris scan sensor, and/or a finger scan sensor. The sensor module 240 may further include a control circuit for controlling one or more sensors included therein. The electronic device 201 may further include a processor configured to control the sensor module 240, as a part of the processor 210 or separately from the processor 210, and may control the sensor module 240 while the processor 210 is in a sleep state.

The input device 250 includes, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) includes a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 includes, for example, a high-definition multimedia interface (HDMI) 272, a universal serial bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MHL) interface, a secure digital (SD) card/multi-media card (MMC) interface, or an infrared data association (IrDA) standard interface.

The audio module 280, for example, may bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image and a video. According to an embodiment of the present disclosure, the camera module 291 may include one or more image sensors (e.g., a front sensor or a back sensor), a lens, an image signal processor (ISP) or a flash (e.g., LED or xenon lamp).

The power management module 295 may manage, for example, power of the electronic device 201. According to an embodiment of the present disclosure, the power management module 295 may include a power management integrated circuit (PMIC), a charger integrated circuit (IC), or a battery gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual charge quantity of the battery 296, and a voltage, a current, or a temperature while charging. The battery 296 may include, for example, a rechargeable battery and/or a solar battery.

The indicator 297 may display a particular state (e.g., a booting state, a message state, a charging state, and the like) of the electronic device 201 or a part (e.g., the processor 210) of the electronic device 201. The motor 298 may convert an electrical signal into a mechanical vibration, and may generate a vibration, a haptic effect, and the like. The electronic device 201 may include a processing device (e.g., a GPU) for supporting a mobile TV. The processing device for supporting a mobile TV may process, for example, media data according to a certain standard such as digital multimedia broadcasting (DMB), digital video broadcasting (DVB), or MediaFLO™.

Each of the above-described component elements of hardware according to an embodiment of the present disclosure may be configured with one or more components, and the names of the corresponding component elements may vary based on the type of electronic device. The electronic device may include at least one of the above-described elements. Some of the above-described elements may be omitted from the electronic device, or the electronic device may further include additional elements. Also, some of the hardware components may be combined into one entity, which may perform functions identical to those of the relevant components before the combination.

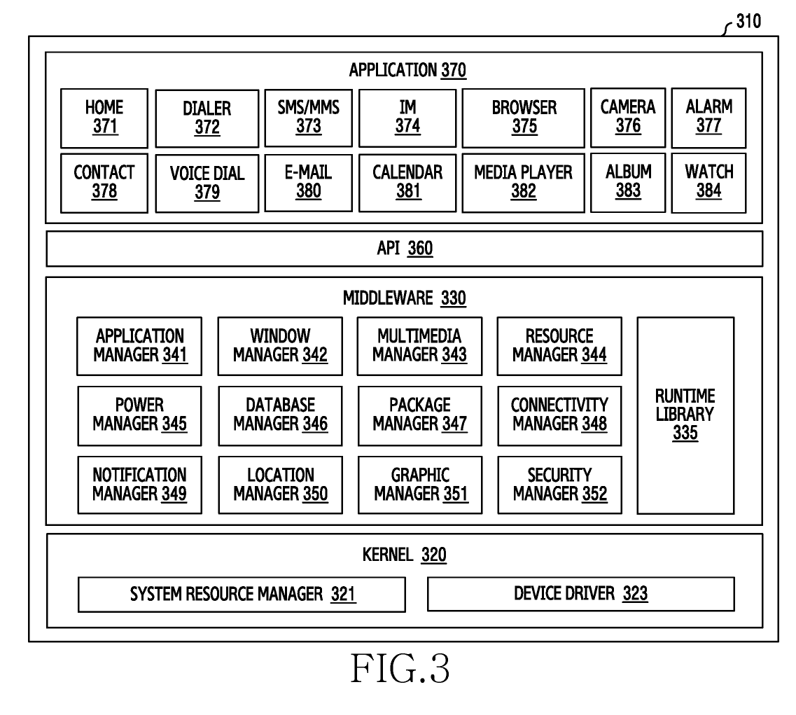

FIG. 3 is a block diagram of a program module according to an embodiment of the present disclosure.

According to an embodiment of the present disclosure, the program module 310 (e.g., the program 140) includes an operating system (OS) for controlling resources related to the electronic device 101 and/or various applications (e.g., the application programs 147) executed in the operating system. The operating system may be, for example, Android™, iOS™, Windows™, Symbian™, Tizen™, Bada™, and the like.

The program module 310 includes a kernel 320, middleware 330, an API 360, and/or applications 370. At least some of the program module 310 may be preloaded on an electronic device, or may be downloaded from the electronic device 102 or 104, or the server 106.

The kernel 320 (e.g., the kernel 141) may include, for example, a system resource manager 321 and/or a device driver 323. The system resource manager 321 may control, allocate, or collect system resources. According to an embodiment of the present disclosure, the system resource manager 321 may include a process management unit, a memory management unit, a file system management unit, and the like. The device driver 323 may include, for example, a display driver, a camera driver, a Bluetooth driver, a shared memory driver, a USB driver, a keypad driver, a Wi-Fi driver, an audio driver, or an inter-process communication (IPC) driver.

For example, the middleware 330 may provide a function required in common by the applications 370, or may provide various functions to the applications 370 through the API 360 so as to enable the applications 370 to efficiently use the limited system resources in the electronic device. According to an embodiment of the present disclosure, the middleware 330 (e.g., the middleware 143) includes at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed. The runtime library 335 may perform input/output management, memory management, the functionality for an arithmetic function, and the like.

The application manager 341 may manage, for example, a life cycle of at least one of the applications 370. The window manager 342 may manage graphical user interface (GUI) resources used by a screen. The multimedia manager 343 may recognize a format required for reproduction of various media files, and may perform encoding or decoding of a media file by using a codec suitable for the corresponding format. The resource manager 344 may manage resources of a source code, a memory, and a storage space of at least one of the applications 370.

The power manager 345 may operate together with, for example, a basic input/output system (BIOS) and the like to manage a battery or power source and may provide power information and the like required for the operations of the electronic device. The database manager 346 may generate, search for, and/or change a database to be used by at least one of the applications 370. The package manager 347 may manage installation or an update of an application distributed in a form of a package file.

For example, the connectivity manager 348 may manage wireless connectivity such as Wi-Fi or Bluetooth. The notification manager 349 may display or notify of an event such as an arrival message, promise, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide all security functions required for system security, user authentication, and the like. According to an embodiment of the present disclosure, when the electronic device 101 has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of OS in order to provide a differentiated function. Further, the middleware 330 may dynamically remove some of the existing components or add new components.

The API 360 (e.g., the API 145) is, for example, a set of API programming functions, and may be provided with a different configuration according to an OS. For example, in the case of Android™ or iOS™, one API set may be provided for each platform. In the case of Tizen™, two or more API sets may be provided for each platform.

The applications 370 (e.g., the application programs 147) include, for example, one or more applications which may provide functions such as a home 371, a dialer 372, an SMS/MMS 373, an instant message (IM) 374, a browser 375, a camera 376, an alarm 377, contacts 378, a voice dial 379, an email 380, a calendar 381, a media player 382, an album 383, a clock 384, health care (e.g., measuring exercise quantity or blood sugar level), or environment information (e.g., providing atmospheric pressure, humidity, or temperature information).

According to an embodiment of the present disclosure, the applications 370 may include an information exchange application that supports exchanging information between the electronic device 101 and the electronic device 102 or 104. The information exchange application may include, for example, a notification relay application for transferring specific information to an external electronic device or a device management application for managing an external electronic device.

For example, the notification relay application may include a function of transferring, to the external electronic device 102 or 104, notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

The device management application may manage (e.g., install, delete, or update), for example, at least one function of the electronic device 102 or 104 communicating with the electronic device (e.g., a function of turning on/off the external electronic device itself (or some components) or a function of adjusting the brightness (or a resolution) of the display), applications operating in the external electronic device, and services provided by the external electronic device (e.g., a call service or a message service).

According to an embodiment of the present disclosure, the applications 370 may include applications (e.g., a health care application of a mobile medical appliance and the like) designated according to an external electronic device (e.g., attributes of the electronic device 102 or 104). The applications 370 may include an application received from an the server 106, or the electronic device 102 or 104. The applications 370 may include a preloaded application or a third party application that may be downloaded from a server. The names of the components of the program module 310 of the illustrated embodiment of the present disclosure may change according to the type of operating system.

According to an embodiment of the present disclosure, at least a part of the programming module 310 may be implemented in software, firmware, hardware, or a combination of two or more thereof. At least some of the program module 310 may be implemented (e.g., executed) by, for example, the processor (e.g., the processor 1410). At least some of the program module 310 may include, for example, a module, a program, a routine, a set of instructions, and/or a process for performing one or more functions.

The term “module” as used in the present document may, for example, mean a unit including one of hardware, software, or firmware or a combination of two or more of them. The term “module” may, for example, be used interchangeably with the terms “unit”, “logic”, “logical block”, “component”, “circuit”, etc. The “module” may be the minimum unit of an integrally constructed component or a part thereof. The “module” may be the minimum unit performing one or more functions or a part thereof as well. The “module” may be implemented mechanically or electronically. For example, the “module” may include at least one of an application-specific integrated circuit (ASIC) chip performing some operations, which are well known to the art or will be developed in the future, a field programmable gate array (FPGA), or a programmable-logic device. At least a part of a device (e.g., modules or functions thereof) or method (e.g., operations) may, for example, be implemented as an instruction that is stored in a computer-readable storage media in a form of a program module. If the instruction is executed by a processor (e.g., the processor 120), the processor may perform a function corresponding to the instruction. The computer-readable storage media may be the memory 130, for example.

The computer-readable recording media may include a hard disk, a floppy disk, a magnetic media (e.g., a magnetic tape), an optical media (e.g., a Compact disc-read only memory (CD-ROM), a digital versatile disk (DVD), a magneto-optical media (e.g., a floptical disk), a hardware device (e.g., a read only memory (ROM), a random access memory (RAM), a flash memory, etc.). Also, the program instruction may include a high-level language code that uses an interpreter, etc. to be executed by a computer, as well as a mechanical language code such as a code made by a compiler. The aforementioned hardware device may be configured to operate as one or more software modules so as to perform operations of various exemplary embodiments.

The module or program module according to an embodiment of the present disclosure may further include at least one or more of the aforementioned constituent elements, or omit some of them, or further include additional other constituent elements. Operations carried out by the module, the program module or the other constituent elements may be executed in a sequential, parallel, repeated or heuristic method. Also, some operations may be executed in different order or may be omitted, or other operations may be added.

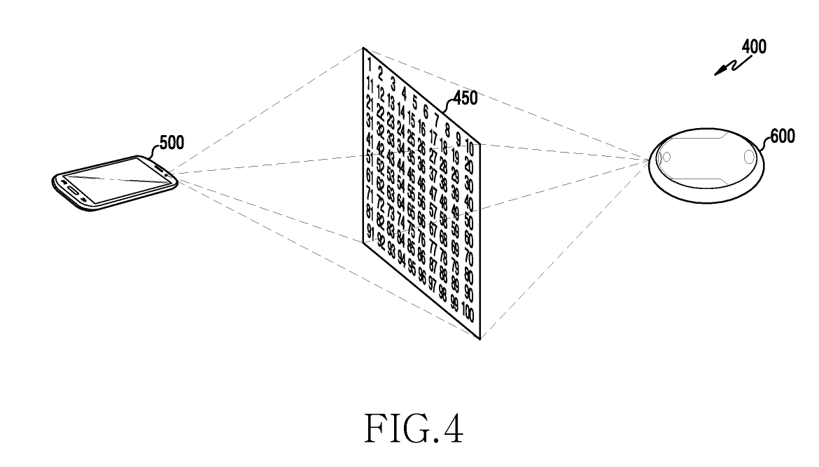

FIG. 4 illustrates a system in which an electronic device controls an external electronic device, according to an embodiment of the present disclosure.

Referring to FIG. 4, the system 400, includes an electronic device 500 and an external electronic device 600. The electronic device 500 may be a device, such as a portable terminal that includes a light projector module, and the external electronic device 600 may be a robot cleaner, a drone, an autonomous vehicle, or a robot that includes a camera and is able to be remotely controlled by the electronic device 500.

The electronic device 500 may provide pattern information 450 to the external electronic device 600 using one of the lights of a beam or a laser. According to an embodiment of the present disclosure, the electronic device 500 may provide pattern information to the external electronic device 600 using sound information. The electronic device 500 may provide pattern information to the external electronic device 600 through wireless communication, such as Bluetooth and the like. The pattern information 450 may correspond to control instructions for controlling the external electronic device 600. The pattern information 450 may correspond to control instructions for controlling the movement of the external electronic device 600, and may control the state of the external electronic device 600.

The external electronic device 600 may obtain, through a camera, all or some of the pattern information 450 in the form of image data, which is provided from the electronic device 500. The external electronic device 600 may identify all or some of the pattern information from the image data. If the pattern information corresponds to control instructions for controlling the movement of the external electronic device 600, the external electronic device 600 may perform the movement according to the pattern information. If the pattern information corresponds to control instructions for controlling the state of the external electronic device 600, the external electronic device 600 may control the state thereof according to the pattern information. The external electronic device 600 may obtain, through a microphone, the pattern information as sound data, which is provided from the electronic device 500. The external electronic device 600 may obtain the pattern information from a communication signal through wireless communication, such as Bluetooth and the like.

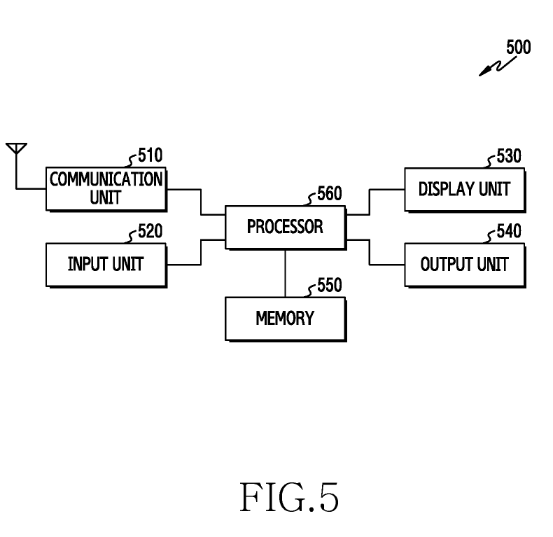

FIG. 5 is a block diagram of an electronic device, according to an embodiment of the present disclosure.

Referring to FIG. 5, the electronic device 500, includes a communication unit 510, an input unit 520, a display unit 530, an output unit 540, a memory 550, and a processor 560.

The communication unit 510 may perform communication in the electronic device 500. The communication unit 510 may communicate with external electronic devices, such as a server or other devices, in various manners. For example, the communication unit 510 may perform at least one of wireless communication or wired communication. The communication unit 510 may access at least one of a mobile communication network or a data communication network. For example, the communication scheme may include LTE (Long Term Evolution), WCDMA (wideband code division multiple access), a GSM (global system for mobile communications), WiFi (wireless fidelity), Bluetooth, NFC (near field communications), or IR (infrared ray). The communication unit 510 may perform a pairing with the external electronic device 600 according to the control of the processor 560. The communication unit 510 may provide the pattern information to the external electronic device 600 according to the control of the processor 560.

The input unit 520 may obtain input data. For example, the input unit 520 may obtain input data in response to a user input. The input unit 520 may include one or more input means. The input unit 520, for example, may include a keypad, a dome switch, physical buttons, a touch panel, or a jog & shuttle. The touch panel may sense a motion on the touch panel (for example, coordinate information on the touch that is detected by user's fingers and external electronic devices (for example, a stylus)), and may transfer the same to the processor 560.

The display unit 530 may include a liquid crystal display (LCD), a light emitting diode (LED) display, an organic light emitting diode (OLED) display, a microelectromechanical systems (MEMS) display, or an electronic paper display. The display unit 530, for example, may include a plurality of light emitting devices. The display unit 530, for example, may be combined with the input unit 520 to implement a touch screen. The display unit 530, which is implemented as a touch screen, may transfer, to the processor 560, a motion that is detected on the surface of the display unit 530 (for example, coordinate information of the touch that is detected by an external electronic device).

The output unit 540 may provide pattern information with a light, such as a beam or a laser. The output unit 540 may be a light projector module, such as a beam projector module or a laser projector module, for providing the light. The output unit 540 may include a speaker to provide the pattern information as sound data.

The memory 550 may store operating programs of the electronic device 500. The memory 550 may store the types of patterns that are used when creating the pattern information. The types of patterns may include a number pattern, a figure pattern, a character pattern, a color pattern, or a modified pattern. The modified pattern may be a specified encryption scheme (for example, OTP (one time password)). In the case of the figure pattern or the character pattern, an instruction corresponding to each of the figure pattern or the character pattern may be allocated and stored.

The processor 560 may create pattern information for controlling the movement of the external electronic device 600, and may provide the pattern information through the output unit 540 in order to control the operation of the external electronic device 600. The pattern information for controlling the movement of the external electronic device 600 may contain pattern information for moving the external electronic device 600 to a specific destination and pattern information for moving the external electronic device 600 along a movement path. The processor 560 may create pattern information corresponding to state information for controlling the state of the external electronic device 600, and may provide the pattern information to the external electronic device 600 through the output unit 540 in order to control the state of the external electronic device 600. According to an embodiment of the present disclosure, the processor 560 may transmit the pattern information to the external electronic device 600 using the communication unit 510.

The processor 560 may configure the type of pattern that is used when creating the pattern information, and may transmit the configured type of pattern to the external electronic device 600. For example, the processor 560 may configure the type of pattern, and may transmit the type of pattern to the external electronic device 600 using the communication unit 510 when it is connected to the external electronic device 600. The type of pattern may be configured by the user, or may be configured to be a specified type of pattern. The processor 560 may create pattern information for controlling the movement of the external electronic device 600 or pattern information for controlling the state of the external electronic device 600 according to a previously determined rule.

In the case of the number pattern, the processor 560 may create pattern information by disposing numbers. For example, the processor 560 may dispose numbers in an N*N matrix in order to create the pattern information. The processor 560 may create the pattern information by changing the disposition of a specific number in the N*N matrix according to the movement control of the external electronic device 600 or according to the state control of the external electronic device 600.

In the case of a figure pattern or a character pattern, the processor 560 may dispose figures or characters in order to create the pattern information. For example, the processor 560 may create pattern information by disposing figures or characters in an N*N matrix. The processor 560 may create pattern information by changing the disposition of the figures or characters in the N*N matrix according to the movement control of the external electronic device 600 or according to the state control of the external electronic device 600. In the case of a figure pattern or a character pattern, numbers may be allocated to the respective figures or characters.

In the case of a color pattern, the processor 560 may dispose numbers, figures, or characters in order to create pattern information. For example, the processor 560 may create the pattern information by disposing numbers, figures, or characters in an N*N matrix. The processor 560 may create the pattern information by adding a specific color to the N*N matrix according to the movement control of the external electronic device 600 or according to the state control of the external electronic device 600.

In the case of the modified pattern (for example, the OTP password), the processor 560, for example, may dispose the OTP password in an N*N matrix by using the OTP password. The processor 560 may create the pattern information by changing the disposition of the OTP password in the N*N matrix according to the movement control of the external electronic device 600 or according to the state control of the external electronic device 600. The processor 560 may create the OTP password by combining two or more patterns, such as a combination of a number and a color or a combination of a figure and a color. The processor 560 may change the OTP password every specified unit of time (for example, every 10 seconds). The processor 560 may change the pattern into a variety of matrixes, such as N*M. The processor 560 may configure the matrix of the pattern that is used in creating the pattern information, and may transmit the configured pattern matrix to the external electronic device 600 when performing a pairing the external electronic device 600. The pattern matrix may be configured by the user, or may be configured to be a specified matrix.

The electronic device 500, according to the embodiment of the present disclosure, may include an output device (for example, the output unit 540) and the processor 560, and the processor 560 may be configured to create pattern information corresponding to control information for one or more external electronic devices 600 and provide the pattern information to the outside of the electronic device 500 through the output device 540 in order to control one or more external electronic devices 600.

The processor 560 may be configured to create the pattern information according to a user input by using at least one pattern of numbers, figures, characters, colors, a combination thereof, or a specified encryption scheme. The processor 560 may be configured to share the pattern information with one or more external electronic devices.

The output device 540 may include a communication module (for example, the communication unit 510), and the processor 560 may be configured to transmit the pattern information to one or more external electronic devices 600 through the communication module 510.

The output device 540 may include a projector, and the processor 560 may be configured to display, as a light including a beam and a laser, the pattern information to the outside of the electronic device 500 through the projector.

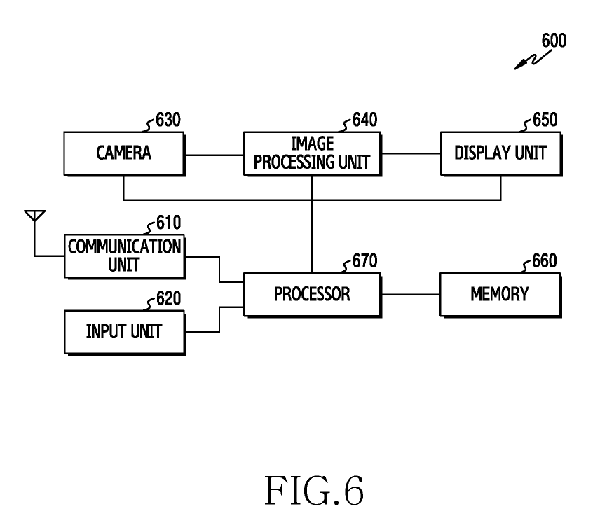

FIG. 6 is a block diagram of an external electronic device, according to an embodiment of the present disclosure.

Referring to FIG. 6, the external electronic device 600, according to the embodiment of the present disclosure, includes a communication unit 610, an input unit 620, a camera 630, an image processing unit 640, a display unit 650, a memory 660, and a processor 670.

The communication unit 610 may perform communication in the external electronic device 600. According to an embodiment of the present disclosure, the communication unit 610 may communicate with the electronic device 500 in various manners. For example, the communication unit 610 may perform at least one of wireless communication or wired communication. For example, the communication unit 610 may perform a pairing with the electronic device 500 using short-range wireless communication, such as WiFi (wireless fidelity), Bluetooth, NFC (near field communications), or IR (infrared ray). The communication unit 610 may be provided with pattern information from the electronic device 500.

The input unit 620 may obtain input data. The input unit 620 may obtain input data in response to a user input. The input unit 620 may include one or more input means. The input unit 620, for example, may include a keypad, a dome switch, physical buttons, a touch panel, or a jog & shuttle. The touch panel may sense a motion on the touch panel (for example, coordinate information on the touch panel that is detected as a result of a user's touch and external electronic devices (for example, a stylus)), and may transfer the same to the processor 670.

The camera 630 may obtain image data. The camera 630 may receive optical signals. The camera 630 may obtain the image data from the optical signal. The camera 630 may include a camera sensor and a signal converter. The camera sensor may convert the optical signal into an electrical image signal. The signal converter may convert an analog image signal to a digital image data.

The image processing unit 640 may process the image data. The image processing unit 640 may process the image data in a frame unit, and may output the processed data corresponding to the characteristics and size of the display unit 650. The image processing unit 640 may compress the image data in a predetermined manner, or may restore the compressed image data to the original image data. The image processing unit 640 may reverse the image data on the pattern information that is received through the camera 630.

The display unit 650 may include a liquid crystal display (LCD), a light emitting diode (LED) display, an organic light emitting diode (OLED) display, a microelectromechanical systems (MEMS) display, or an electronic paper display. The display unit 650, for example, may include a plurality of light emitting devices. The display unit 650, for example, may be combined with the input unit 620 to implement a touch screen. According to an embodiment of the present disclosure, the display unit 650, which is implemented as a touch screen, may transfer, to the processor 670, a motion that is detected on the surface of the display unit 650 (for example, coordinate information of a touch input that is detected by an external electronic device).

The memory 660 may store operating programs of the external electronic device 600. The memory 660 may store the types of patterns that are stored in the electronic device 500 in order to identify the pattern information that is provided from the electronic device 500. The types of patterns may include a number pattern, a figure pattern, a character pattern, a color pattern, or a modified pattern. The modified pattern may be implemented to be a specified encryption scheme. In the case of the figure pattern or the character pattern, an instruction corresponding to each of the figure pattern or the character pattern may be allocated and stored.

The processor 670 may analyze the image data that is obtained from the camera 630 in order to identify the pattern information on the movement control, which is contained in the image data. The processor 670 may configure a destination or movement path based on the identified pattern information. The processor 670 may control the movement of the external electronic device 600 according to the configured destination or movement path.

The processor 670 may analyze the image data that is obtained from the camera 630 in order to identify the pattern information on the state control, which is contained in the image data. The processor 670 may identify the state of the external electronic device 600 that is desired to be controlled by the electronic device 500 based on the identified pattern information. The processor 670 may control the state of the external electronic device 600 according to the identified state. According to an embodiment of the present disclosure, the processor 670 may configure a destination, a movement path, or the state of the external electronic device 600 based on the pattern information that is received from the communication unit 610.

The processor 670 may receive information that is related to the type of pattern or a pattern matrix, which is selected in the electronic device 500, when it is connected to the electronic device 500. In the case of the number pattern, the processor 670 may analyze the numbers that are disposed in an N*N matrix from the image data. The processor 670 may control the movement, or the state, of the external electronic device 600 according to the analyzed result.

In the case of a figure pattern or character pattern, the processor 670 may analyze the figures or characters that are disposed in an N*N matrix from the image data. The processor 670 may identify the numbers that are allocated to the figures or characters. The processor 670 may control the movement, or the state, of the external electronic device 600 according to the identified result.

In the case of the color pattern, the processor 670 may identify numbers, figures, or characters to which a specific color is added in an N*N matrix that is identified in the image data. The processor 670 may control the movement or the state according to the identified specific color.

In the case of the modified pattern (for example, the OTP password), the processor 670 may analyze the OTP password that is disposed in an N*N matrix from the image data. The processor 670 may control the movement or the state according to the analyzed result.

According to an embodiment of the present disclosure, the external electronic device 600 may include a microphone. The microphone may obtain sound data that is provided from a speaker of the electronic device 500. The external electronic device 600 may identify pattern information from the obtained sound data. The external electronic device 600 may configure a destination, a movement path, or the state of the external electronic device 600 based on the identified pattern information.

The electronic device (for example, the external electronic device 600), according to an embodiment of the present disclosure, may include an input device and the processor 670. The processor 670 may be configured to obtain pattern information corresponding to control information for the electronic device 600 using the input device 620 and may control the electronic device 600 based on the pattern information.

The processor 670 may identify whether the pattern information is intended for movement control or state control. If the pattern information is intended for movement control, the processor 670 may identify a reference point that is contained in the pattern information, control the movement based on the reference point according to whether the movement is made in the direction facing the electronic device (for example, the electronic device 500) that provides the identified pattern information and control the movement according to the pattern information. If the pattern information is intended for state control, the processor 670 may control the state according to the pattern information.

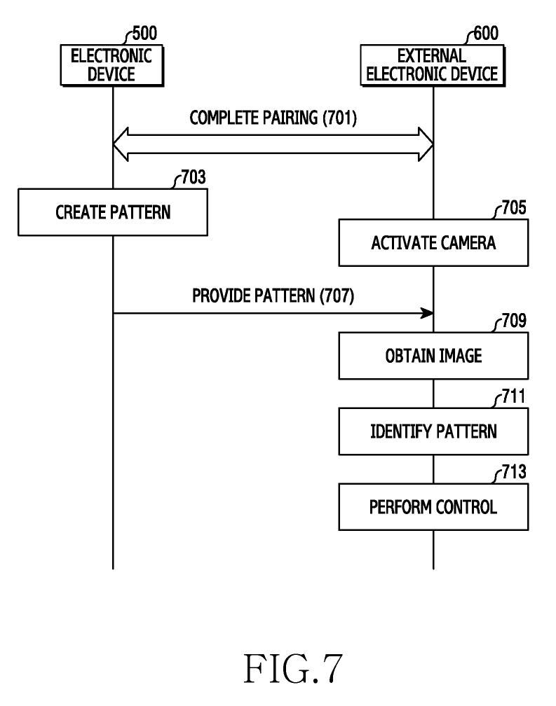

FIG. 7 is a flow diagram of an operation of an electronic device and an external electronic device, according to an embodiment of the present disclosure.

Referring to FIG. 7, in step 701, the electronic device 500 and the external electronic device 600 complete a pairing with each other. The electronic device 500 may configure the type of pattern or a pattern matrix when performing a pairing with the external electronic device 600. The electronic device 500 may transmit the configured type of pattern or pattern matrix to the external electronic device 600. The type of pattern may encompass a number pattern, a figure pattern, a character pattern, a color pattern, or a modified pattern. The modified pattern may be a specified encryption scheme. The pattern matrix may be an N*N matrix or an N*M matrix. According to an embodiment of the present disclosure, the electronic device 500 may transmit an encryption key for decrypting the encrypted pattern information or information about the encryption scheme when performing a pairing with the external electronic device 600. The electronic device 500 may provide a camera activation time when performing a pairing with the external electronic device 600. For example, the processor 560 may provide time information (for example, 3:00, 5:00, or 7:00) for activating the camera of the external electronic device 600.

In step 703, the electronic device 500 creates pattern information for controlling the external electronic device 600 that has been paired. The electronic device 500 may create pattern information for controlling the external electronic device 600 based on the type of pattern that is configured when performing a pairing with the external electronic device 600. The pattern information may control the movement of the external electronic device 600, or may control the state of the external electronic device 600.

In step 705, the external electronic device 600 activates the camera for obtaining the pattern information in image data, which is provided by the electronic device 500. In step 707, the electronic device 500 provides the pattern information, which has been created in step 703, to the outside of the electronic device 500 using a light, such as a beam or a laser. In step 707, the electronic device 500 provides the created pattern information to the external electronic device 600 using the communication unit 510. For example, the electronic device 500 may transmit the created pattern information using Bluetooth. In step 707, the electronic device 500 may convert the created pattern information into sound data to be provided to the external electronic device 600. For example, the electronic device 500 may create audio information corresponding to the pattern information, and may provide the audio information to the external electronic device 600 using an output device, such as a speaker.

In step 709, the external electronic device 600 obtains the pattern information in image data, which is provided from the electronic device 500, using the camera. In step 709, the external electronic device 600 receives the pattern information that is provided from the electronic device 500 through wireless communication. According to an embodiment of the present disclosure, in step 709, the external electronic device 600 receives the pattern information that is provided from the electronic device 500 using an input device, such as a speaker.

In step 711, the external electronic device 600 identifies the pattern information from the obtained image data. Since the pattern information is created in the type of pattern that is configured when performing the pairing, the external electronic device 600 may identify the pattern information. According to an embodiment of the present disclosure, the external electronic device 600 may decrypt the encrypted pattern information using the transmitted encryption key or encryption scheme. In step 713, the external electronic device 600 performs control based on the identified pattern. If the pattern information, which is identified from the image data, is intended to control the movement of the external electronic device 600, the external electronic device 600 may control the movement according to the identified pattern information. If the pattern information, which is identified from the image data, is intended to control the state of the external electronic device 600, the external electronic device 600 may configure the state of the external electronic device 600 according to the identified pattern information.

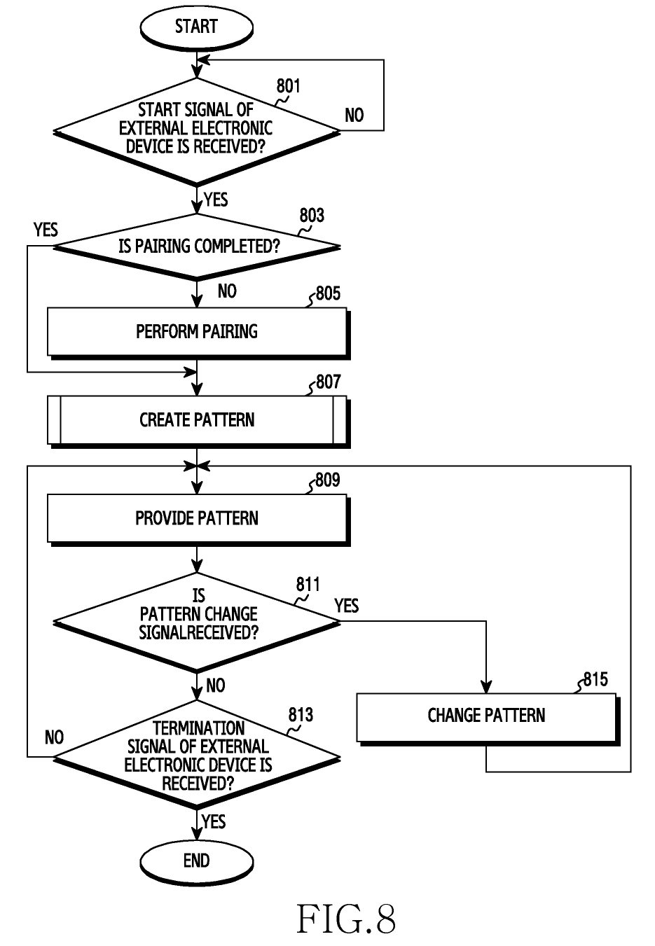

FIG. 8 is a flowchart of a method of an electronic device, according to an embodiment of the present disclosure.

Referring to FIG. 8, in step 801, the electronic device 500 identifies the reception of a control start signal for controlling the external electronic device 600 from the input unit 520. When the control start signal is received, the electronic device 500 performs step 803. In step 803, the electronic device 500 identifies whether a pairing with the external electronic device 600 is completed. If the pairing with the external electronic device 600 is completed in step 803, the electronic device 500 performs step 807. If the pairing with the external electronic device 600 is not completed in step 803, the electronic device 500 performs step 805. In step 805, the electronic device 500 performs a pairing with the external electronic device 600. The electronic device 500 may configure the type of pattern or a pattern matrix that is to be used when creating pattern information, and may transmit the same to the external electronic device 600. The type of pattern may encompass a number pattern, a figure pattern, a character pattern, a color pattern, or a modified pattern. The modified pattern may be a specified encryption scheme. In the case of a figure pattern or a character pattern, an instruction corresponding to each of the figure pattern or the character pattern may be allocated. The type of pattern or the pattern matrix may be configured by the user, or may be configured to be a specified pattern or specified pattern matrix.

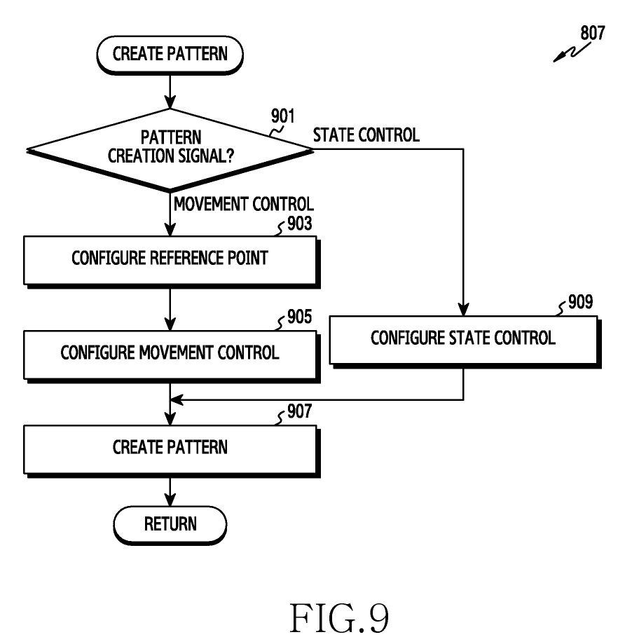

In step 807, the electronic device 500 creates pattern information for controlling the external electronic device 600. The electronic device 500 may create pattern information for controlling the movement of the external electronic device 600, or may create pattern information for controlling the state of the external electronic device 600 according to a previously determined rule. The operation of creating the pattern information will be described in more detail with reference to FIG. 9. In step 809, the electronic device 500 provides the created pattern information. The electronic device 500 may provide the pattern information as a light, such as a beam or a laser. According to an embodiment of the present disclosure, the electronic device 500 may provide the pattern information to a specified position. For example, the electronic device 500 may move to provide the pattern information to a specified position. In addition, the electronic device 500 may move the output unit 540 to provide the pattern information to a specified position.

If a signal for changing the pattern information is received from the input unit 520 in step 811, the electronic device 500 performs step 815. If a signal for changing the pattern information is received from the user or if a signal that is related to the change in the position of the electronic device 500 is received, the electronic device 500 may identify the same as a signal for changing the pattern information. Since the pattern information is changed every specific unit of time in the case where the type of pattern corresponds to the OTP password, the electronic device 500 may identify the same as a signal for changing the pattern information.

In step 815, the electronic device 500 changes the pattern information for controlling the external electronic device 600 according to the change signal, and then performs step 809. If the signal for changing the pattern information is not received in step 811, the electronic device 500 performs step 813. In step 813, if a signal for terminating the control of the external electronic device 600 is received, the electronic device 500 terminates the process. In step 813, if a signal for terminating the control of the external electronic device 600 is not received, the electronic device 500 returns to step 809 in order to continue to provide the pattern information.

FIG. 9 is a flowchart of a method for creating a pattern in an electronic device, according to an embodiment of the present disclosure.

Referring to FIG. 9, in step 901, the electronic device 500 receives, from the input unit 520, a signal for creating pattern information for controlling the external electronic device 600. If the pattern information is related to the movement control, the electronic device 500 performs step 903. In step 903, the electronic device 500 may configure a reference point. The reference point may configure the position that is a base for the start of the movement of the external electronic device 600. In step 905, the electronic device 500 creates movement information for the external electronic device 600 based on the reference point. In step 907, the electronic device 500 creates pattern information based on the created movement information. Similar to step 805, the electronic device 500 may create pattern information based on the type of pattern or a pattern matrix that is configured when performing a pairing with the external electronic device 600. The movement information may be a movement path of the external electronic device 600 or a destination of the external electronic device 600.

In step 901, the electronic device 500 receives, from the input unit 520, a creation signal of pattern information for controlling the external electronic device 600. If the pattern information is related to the state control, the electronic device 500 performs step 909. The electronic device 500 may configure the state of the external electronic device 600 to perform step 907. In step 907, the electronic device 500 creates pattern information based on the state of the external electronic device 600 to be configured. Similar to step 805, the electronic device 500 may create pattern information based on the type of pattern or a pattern matrix that is configured when performing a pairing with the external electronic device 600. The state configuration, for example, may configure the state of the external electronic device 600, and various states (for example, the moving speed or the entry into a low power mode of the external electronic device 600) may be configured.

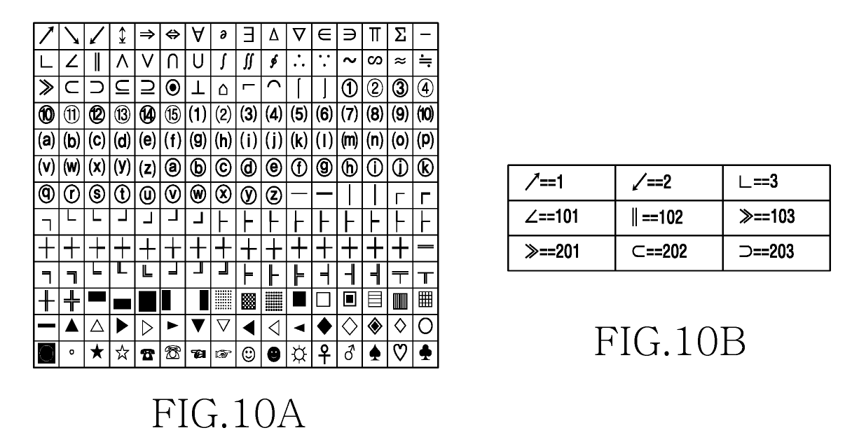

FIGS. 10A and 10B illustrate instructions that are allocated to figures and characters, which are used in the electronic device, when creating pattern information, according to an embodiment of the present disclosure.

Referring to FIGS. 10A and 10B, the pattern may be created by a plurality of figures by the electronic device 500 as shown in FIG. 10A. Instructions (for example, numbers) may be allocated to the respective figures as shown FIG. 10B. In the case where the electronic device 500 desires to control the movement of the external electronic device 600, as shown in FIG. 10B, numbers corresponding to the instructions may be allocated to the respective figures that are created in FIG. 10B. The numbers may indicate movement instructions in a specific direction, wherein ‘1’ may represent a forward movement of the external electronic device 600, and ‘2’ and ‘3’ may represent a backward movement and a left movement, respectively.

In the case where the electronic device 500 desires to control the state of the external electronic device 600, as shown in FIG. 10B, numbers corresponding to the instructions may be allocated to the respective figures that are created in the diagram of FIG. 10A. The numbers may indicate control instructions, wherein ‘201’ may represent a low power mode, and ‘202’ and ‘203’ may represent an increase in the moving speed and a decrease in the moving speed, respectively.

In the case where the electronic device 500 desires to control the movement of the external electronic device 600, the electronic device 500 may create pattern information using the figures of the movement instructions. In the case where the electronic device 500 desires to control the state of the external electronic device 600, the electronic device 500 may create pattern information using the figures of the control instructions. In the case where the electronic device 500 desires to control the movement and state of the external electronic device 600, the electronic device 500 may create pattern information by combining the figures of the movement instructions and the control instructions.

The external electronic device 600 may obtain the pattern information in an image, which is provided from the electronic device 500. The external electronic device 600 may identify the pattern information from the obtained image. The external electronic device 600 may identify the instructions based on the numbers that are allocated to the respective figures. The external electronic device 600 may identify whether the pattern information is intended for movement control or state control. The external electronic device 600 may control the movement, or the state, of the external electronic device 600 using the pattern information according to the identified result.

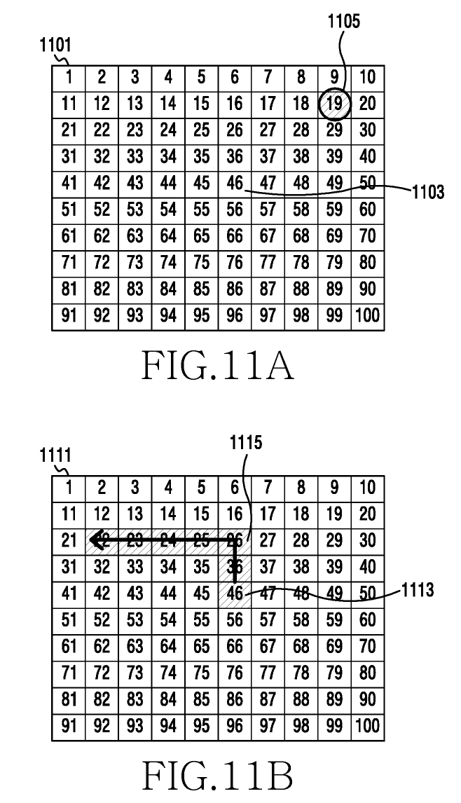

FIGS. 11A and 11B illustrate pattern information provided by an electronic device, according to an embodiment of the present disclosure.

Referring to FIGS. 11A and 11B, the electronic device 500 may dispose a plurality of numbers as shown in FIG. 11A, and may change the color of the numbers corresponding to the destination of the external electronic device 600 in order to control the movement of the external electronic device 600, thereby creating the pattern information 1101. In FIGS. 11A and 11B, diagonal line pattern represents different color from surroundings. The electronic device 500 may configure a specific number to be a reference point 1103 in the pattern information 1101. The electronic device 500 may configure a number corresponding to the final destination of the external electronic device 600 to be a destination 1105. The electronic device 500 may provide the pattern information 1101 to the external electronic device 600.

The external electronic device 600 may obtain the pattern information as image data, which is provided from the electronic device 500. The external electronic device 600 may identify the pattern information from the obtained image data. The external electronic device 600 may correct the current position of the external electronic device 600 such that the reference point 1103 is positioned in the central portion of the obtained image data. The external electronic device 600 may move to the destination 1105 based on the reference point 1103.

The electronic device 500 may dispose a plurality of numbers as shown in FIG. 11B, and may change the color of the numbers corresponding to the movement path of the external electronic device 600 in order to control the movement of the external electronic device 600, thereby creating the pattern information 1111. The electronic device 500 may configure a specific number to be a reference point 1113 in the pattern information 1111. The electronic device 500 may change the color of the numbers corresponding to the movement path 1115 of the external electronic device 600. The electronic device 500 may provide the pattern information 1111 to the external electronic device 600.

The external electronic device 600 may obtain the pattern information as image data, which is provided from the electronic device 500. The external electronic device 600 may identify the pattern information from the obtained image data. The external electronic device 600 may correct the current position of the external electronic device 600 such that the reference point 1113 is positioned in the central portion of the obtained image data. Based on the reference point 1113, the external electronic device 600 may move along the movement path 1115 of which the color has been changed.

An operating method of the electronic device 500 includes an output device (for example, the output unit 540) and the processor 560, creating pattern information corresponding to control information for one or more external electronic devices 600 using the processor 560 and providing the pattern information to the outside of the electronic device 500 using the output device (for example, the output unit 540) in order to control one or more external electronic devices 600.

The operation of creating the pattern information may include creating the pattern information according to a user input using at least one pattern type of numbers, figures, characters, colors, a combination thereof, or a specified encryption scheme.

The method may further include sharing the pattern information with one or more external electronic devices 600 when the one or more external electronic devices 600 are connected.

The output device may include a communication module (for example, the communication unit 510), and the operation of providing the pattern information to the outside of the electronic device 500 may include transmitting the pattern information to one or more external electronic devices 600 through the communication module (for example, the communication unit 510).

The output device may include a projector (for example, the output unit 540), and the operation of providing the pattern information to the outside of the electronic device 500 may include displaying the pattern information as a light including a beam or a laser to the outside of the electronic device 500 using the projector (for example, the output unit 540).

The operation of creating the pattern information may include creating pattern information for controlling the movement of one or more external electronic devices 600 or creating pattern information for controlling the states of one or more external electronic devices 600.

The operation of creating the pattern information may include configuring a reference point that is the reference position for controlling the movement of one or more external electronic devices 600.

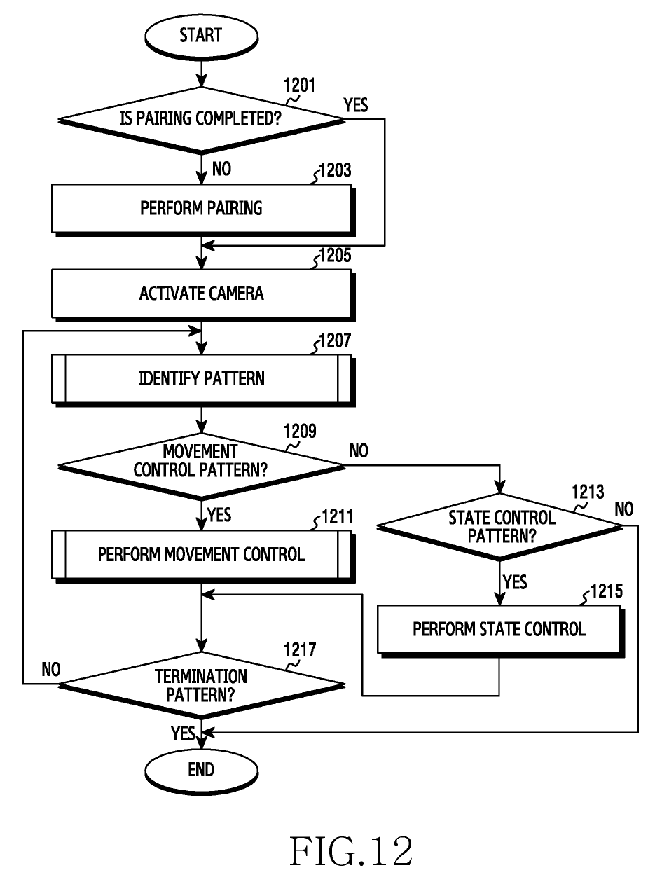

FIG. 12 is a flowchart of a method of an external electronic device, according to another embodiment of the present disclosure.

Referring to FIG. 12, in step 1201, the external electronic device 600 identifies whether a pairing with the electronic device 500 is completed. If the pairing between the external electronic device 600 and electronic device 500 is not completed as a result of the identification in step 1201, the external electronic device 600 performs a pairing with the electronic device 500 in step 1203. The external electronic device 600 may receive the type of pattern or a pattern matrix from the electronic device 500 while performing a pairing with the electronic device 500. The external electronic device 600, which has performed the pairing with the electronic device 500 in step 1203, performs step 1205. If the pairing between the external electronic device 600 and electronic device 500 has been completed as a result of the identification in step 1201, the external electronic device 600 performs step 1205.

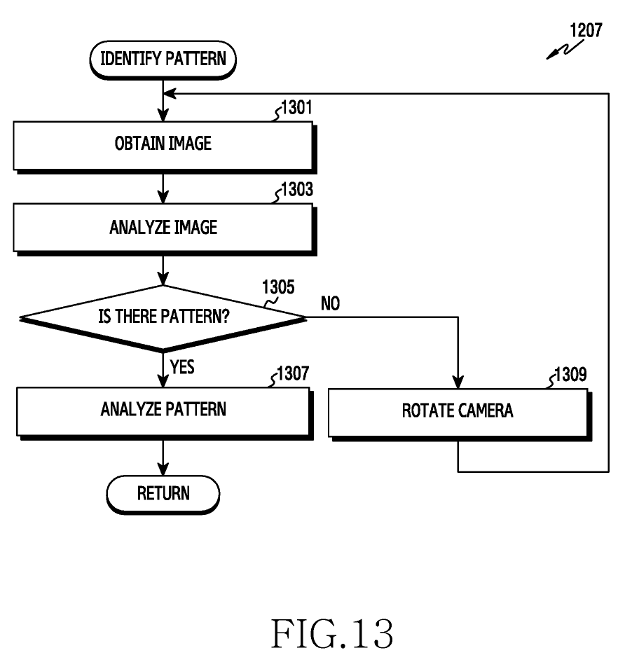

In step 1205, the external electronic device 600 activates a camera in order to obtain image data as a light that is provided from the electronic device 500. According to an embodiment of the present disclosure, the external electronic device 600 may activate the camera 630 at a specified time. In step 1207, the external electronic device 600 identifies the pattern information using the image data that is obtained from the camera 630. The operation of identifying the pattern information will be described in more detail with reference to FIG. 13.

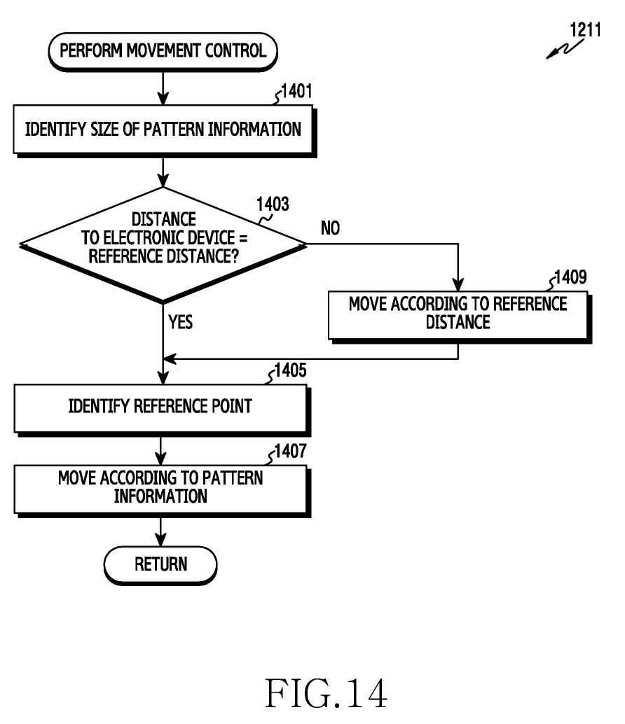

In step 1209, the external electronic device 600 identifies whether the pattern information, which has been identified in step 1207, is intended for movement control. If the pattern information is intended for movement control in step 1209, the external electronic device 600 performs step 1211. In step 1211, the external electronic device 600 controls the movement based on the pattern information. The operation of controlling the movement will be described in more detail with reference to FIG. 14.

If the identified pattern information is not intended for movement control in step 1209, the external electronic device 600 performs step 1213. In step 1213, the external electronic device 600 identifies whether the pattern information is intended for state control. If the pattern information is intended for state control as a result of the identification in step 1213, the external electronic device 600 performs step 1215. In step 1215, the external electronic device 600 identifies the pattern information in order to control the state to correspond to the pattern information. If a termination pattern is received in step 1217, the external electronic device 600 terminates the process. If a termination pattern is not received in step 1217, the external electronic device 600 returns to step 1207. In step 1207, the external electronic device 600 may continue to track the pattern information using light that is provided from the electronic device 500 to move according to the pattern information until the termination pattern is received. Furthermore, although the external electronic device 600 identifies whether the pattern information is intended for movement control in step 1209, the present disclosure is not limited thereto. Similar to step 1203, the external electronic device 600 may receive, from the electronic device 500, the information on whether the pattern information is related to movement control or state control when performing a pairing to identify the same.

FIG. 13 is a flowchart of a method in which an external electronic device identifies a pattern, according to an embodiment of the present disclosure.

Referring to FIG. 13, the external electronic device 600 obtains image data through the camera 630 in step 1301. In step 1303, the external electronic device 600 analyzes the obtained image data. In step 1305, the external electronic device 600 performs step 1307 if all or some of the pattern information that is created on the basis of the type of pattern or the pattern matrix, which is configured at the time of pairing, is contained in the image data.

In step 1305, the external electronic device 600 perform steps 1309 if all or some of the pattern information that is created on the basis of the type of pattern, which is configured at the time of pairing, is not contained in the image data. In step 1309, the external electronic device 600 rotates the camera 630, and repeats step 1301. According to an embodiment of the present disclosure, the external electronic device 600 obtains the pattern information after moving to a specified position. In step 1307, the external electronic device 600 analyzes the pattern information that is contained in the image data, and performs step 1209 of FIG. 12.

FIG. 14 is a flowchart of a method for performing movement control in an external electronic device, according to an embodiment of the present disclosure.

Referring to FIG. 14, in step 1401, the external electronic device 600 identifies the size of the pattern information based on the pattern information that is identified in step 1207 of FIG. 12. In step 1403, the external electronic device 600 identifies whether the distance to the electronic device 500 is the same as a reference distance based on the identified size of the pattern information, which has been identified in step 1401. If the distance to the electronic device 500 is the same as the reference distance as a result of the identification in step 1403, the external electronic device 600 performs step 1405. In step 1405, the external electronic device 600 identifies a reference point from the pattern information, and performs step 1407.

If the distance to the electronic device 500 is not the same as the reference distance as a result of the identification in step 1403, the external electronic device 600 performs step 1409. In step 1409, the external electronic device 600 controls the movement using the size of the pattern information until the distance to the electronic device 500 becomes equal to the reference distance. When the distance to the electronic device 500 becomes equal to the reference distance, the external electronic device 600 performs step 1405. In step 1405, the external electronic device 600 identifies the reference point from the pattern information.

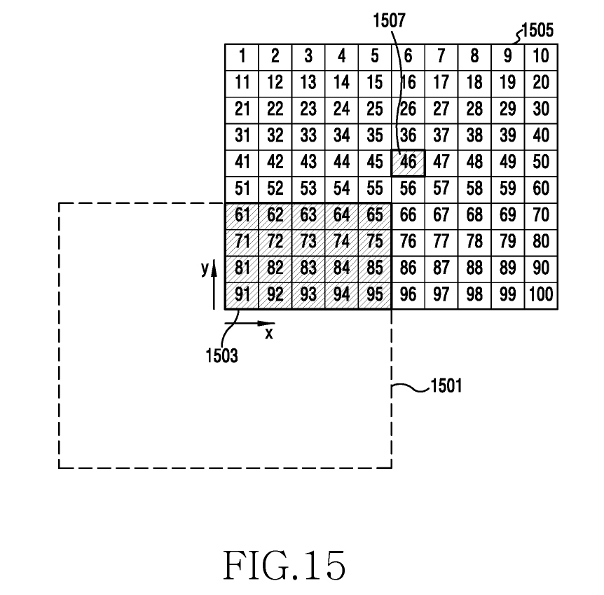

In step 1405, the external electronic device 600 corrects the position of the external electronic device 600 such that the reference point is positioned in the image data. If the reference point is positioned in the image data in step 1405, the external electronic device 600 performs step 1407. In step 1407, the external electronic device 600 moves according to the pattern information. The external electronic device 600 performs step 1217 of FIG. 12 after performing step 1407. The operation of controlling the distance to the electronic device 500 using the size of the pattern information will be described in more detail with reference to FIGS. 15, 16A, 16B, 17A and 17B.

FIG. 15 illustrates a method for finding a reference point in the pattern information, according to an embodiment of the present disclosure.

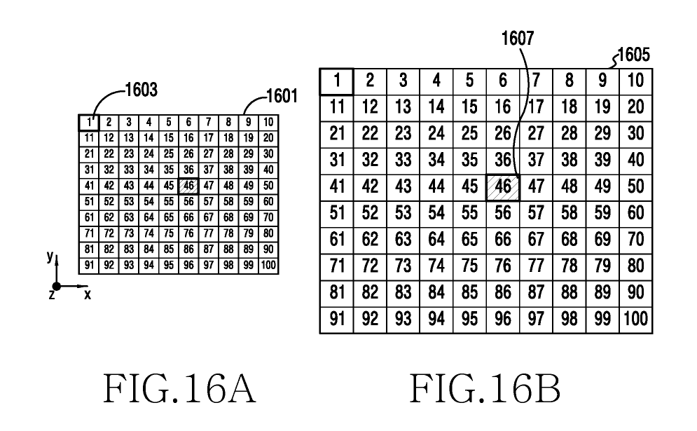

FIGS. 16A and 16B illustrate a method for finding a reference point in the pattern information, according to another embodiment of the present disclosure.

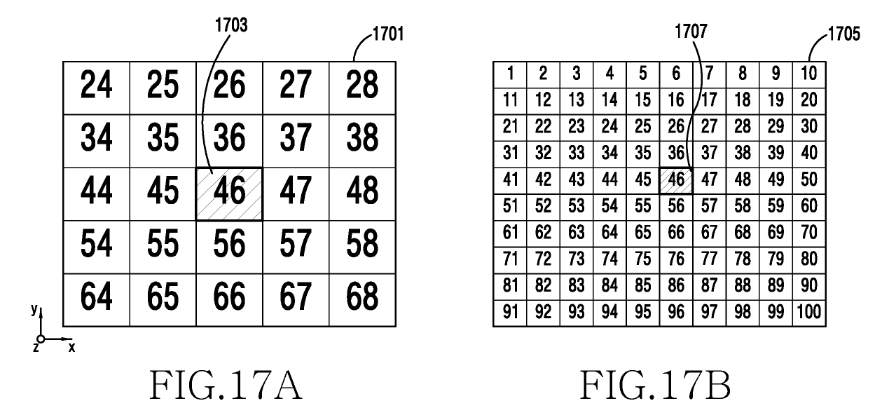

FIGS. 17A and 17B illustrate a method for finding a reference point in the pattern information, according to another embodiment of the present disclosure.

Referring to FIGS. 15, 16A, 16B, 17A and 17B, the external electronic device 600 may obtain the first image data 1501 through the camera 630 in FIG. 15. The external electronic device 600 may identify the state in which all or some 1503 of the pattern information that is created on the basis of the type of pattern or a pattern matrix, which has been configured at the time of pairing, is contained in the first image data 1501.

The external electronic device 600 may obtain the second image data 1505 by rotating the camera 630 in order to obtain all of the pattern information. The external electronic device 600 may analyze the pattern information that is contained in the first image data 1501, and may rotate the camera 630 in the x-axis and y-axis to identify a reference point of the pattern information. For example, in FIG. 15, the external electronic device 600 may identify some of the numbers from 1 to 100 in a 10*10 matrix from the first image data 1501. The external electronic device 600 may control the rotation of the camera 630 so as to identify the numbers from 1 to 100 in the 10*10 matrix. The external electronic device 600 may identify the reference point 1507 from the second image data 1505, and may perform movement control or state control according to the pattern information by starting from the reference point 1507.

As shown in FIG. 16A, the external electronic device 600 may obtain image data 1601 through the camera 630. The external electronic device 600 may identify pattern information from the obtained image data 1601. The external electronic device 600 may select a specific number 1603 from among the numbers that are contained in the pattern information in order to identify the size of the pattern information. If the size of a specific number 1603 is less than that of a specific pixel, the external electronic device 600 may reduce the distance between the external electronic device 600 and the electronic device 500 (for example, processor 560) until the size of the specific number 1603 becomes equal to that of the specific pixel. The external electronic device 600 may continue to identify the size of the specific number 1603 while reducing the distance to the electronic device 500 (for example, processor 560). For example, the external electronic device 600 may move along the z-axis in order to adjust the distance between the external electronic device 600 and the electronic device 500 (for example, processor 560).

When the size of the specific number 1603 becomes equal to that of the specific pixel, the external electronic device 600 may identify that the distance between the external electronic device 600 and the electronic device 500 (for example, processor 560) is the same as the reference distance. The external electronic device 600 may identify a reference point 1607 from the obtained image data 1605 as shown in FIG. 16B. The external electronic device 600 may move according to the pattern information by starting from the reference point 1607.

When some of the pattern information is identified in the image data 1605 in which the size of the specific number 1603 becomes equal to that of the specific pixel, the external electronic device 600 may control the rotation of the camera 630 or the movement of the external electronic device 600 in order to identify all of the pattern information from the image data 1605. If all of the pattern information is identified from the image data 1605, the external electronic device 600 may identify whether the camera 630 faces the electronic device 500. If the camera 630 does not face the electronic device 500, the external electronic device 600 may correct the position of the external electronic device 600 such that the camera 630 faces the electronic device 500. For example, the camera 630 may obtain the pattern information as image data, which is reflected on a wall, instead of directly obtaining the pattern information as image data, which is provided from the electronic device 500. In this case, the external electronic device 600 may correct the position of the external electronic device 600 in order for the camera 630 to directly obtain the pattern information that is provided on the wall.

As shown in FIG. 17A, the external electronic device 600 may obtain image data 1701 through the camera 630. The external electronic device 600 may identify the pattern information from the obtained image data 1701. The external electronic device 600 may select a specific number 1703 from among the numbers that are contained in the pattern information in order to identify the size of the pattern information. If the size of the specific number 1703 is greater than that of a specific pixel, the external electronic device 600 may increase the distance between the external electronic device 600 and the electronic device 500 (for example, processor 560) until the size of the specific number 1703 becomes equal to that of the specific pixel. The external electronic device 600 may continue to identify the size of the specific number 1703 while increasing the distance to the electronic device 500 (for example, processor 560). For example, the external electronic device 600 may move along the z-axis in order to adjust the distance between the external electronic device 600 and the electronic device 500 (for example, processor 560).

When the size of the specific number 1703 becomes equal to that of the specific pixel, the external electronic device 600 may identify that the distance between the external electronic device 600 and the electronic device 500 (for example, processor 560) is the same as the reference distance. The external electronic device 600 may identify a reference point 1707 from the obtained image data 1705 as shown in FIG. 17B. The external electronic device 600 may move according to the pattern information by starting from the reference point 1707. Although the reference point is described to be positioned around the central portion of the pattern information in an embodiment of the present disclosure, the present disclosure is not limited thereto. The reference point may be positioned in any place on the pattern information when the electronic device 500 creates the pattern information.

An operating method of an electronic device (for example, the external electronic device 600) that includes an input device (for example, the camera 630) and the processor 670, includes obtaining pattern information corresponding to control information for the electronic device (for example, the external electronic device 600) using the input device (for example, the camera 630), and controlling the electronic device (for example, the external electronic device 600) at least based on the pattern information using the processor 670.

The operation of controlling the electronic device (for example, the external electronic device 600) includes identifying whether the pattern information is intended for movement control and identifying whether the pattern information is intended for state control.

The operation of identifying whether the pattern information is intended for the movement control may further include identifying a reference point that is contained in the pattern information, controlling the movement based on the reference point according to whether the movement is made in the direction facing the electronic device (for example, the electronic device 500) that provides the identified pattern information, and controlling the movement according to the pattern information.

The operation of identifying whether the pattern information is intended for state control may further include controlling the state according to the pattern information.

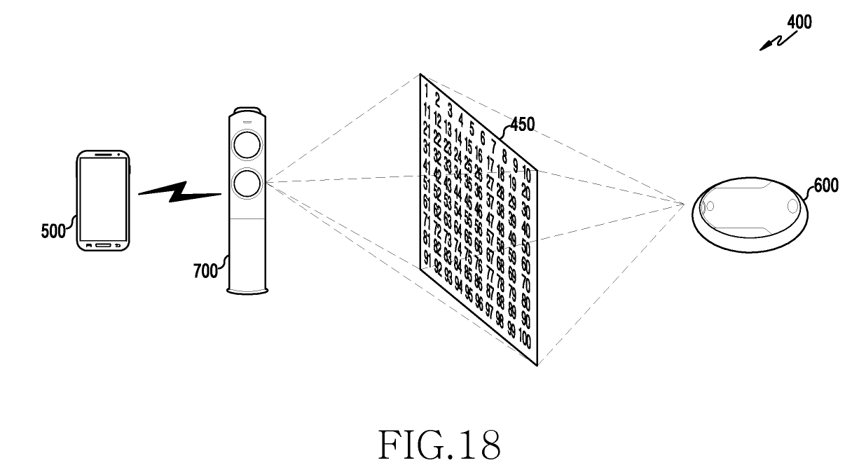

FIG. 18 illustrates a system in which an electronic device controls an external electronic device using another external electronic device, according to an embodiment of the present disclosure.

Referring to FIG. 18, the system 400, according to an embodiment of the present disclosure, includes the electronic device 500, the external electronic device 600 and a peripheral device 700. The electronic device 500 may be a device, such as a portable terminal, a notebook, or a server, which is able to communicate with the peripheral device 700 and is able to control the external electronic device 600 through the peripheral device 700. The external electronic device 600 may be a device, such as a robot cleaner, a drone, an autonomous vehicle, or a robot, which includes the camera 630 and is able to be remotely controlled by the electronic device 500. The peripheral device 700 may be a device, such as a refrigerator or an air conditioner, which includes a light projector module and is able to communicate with the electronic device 500.

The electronic device 500 may perform wireless communication with the peripheral device 700, and may control the peripheral device 700 to provide the pattern information through the wireless communication.

The peripheral device 700 may provide the pattern information 450 to the external electronic device 600 using light from a beam or a laser. According to an embodiment of the present disclosure, the peripheral device 700 may provide the pattern information to the external electronic device 600 using sound information. The peripheral device 700 may provide the pattern information to the external electronic device 600 through wireless communication, such as Bluetooth and the like. The pattern information 450 may correspond to control instructions for controlling the external electronic device 600. The pattern information 450 may correspond to control instructions for controlling the movement of the external electronic device 600, or may correspond to control instructions for controlling the state of the external electronic device 600.

The external electronic device 600 may obtain, through the camera, the pattern information 450 as image data, which is provided from the peripheral device 700. The external electronic device 600 may identify the pattern information from the image data. If the pattern information corresponds to control instructions for controlling the movement of the external electronic device 600, the external electronic device 600 may move according to the pattern information. If the pattern information corresponds to control instructions for controlling the state of the external electronic device 600, the external electronic device 600 may control the state according to the pattern information.

As described above, an electronic device and method is provided for controlling an external electronic device, the electronic device may create pattern information for changing the movement and state of the external electronic device, and may provide the pattern information using a beam or a laser in order to control the external electronic device.

While the present disclosure has been shown and described with reference to certain embodiments thereof, it will be understood by those skilled in the art that various changes in form and details may be made therein without departing from the spirit and scope of the present disclosure as defined by the appended claims and their equivalents.

What is claimed is:

1. An electronic device comprising:
an output device; and
a processor configured to:
create pattern information corresponding to control information for one or more external electronic devices, and
provide the pattern information to outside of the electronic device through the output device to control the one or more external electronic devices.

2. The electronic device of claim 1, wherein the processor is further configured to create the pattern information based on at least one pattern type of numbers, figures, characters, colors, and a specified encryption scheme.

3. The electronic device of claim 2, wherein the processor is further configured to provide the pattern information to the one or more external electronic devices.

4. The electronic device of claim 1, wherein the output device comprises a communication module and the processor is further configured to transmit the pattern information to the one or more external electronic devices through the communication module.

5. The electronic device of claim 1, wherein the output device comprises a projector, and the processor is further configured to display the pattern information as a light from a beam or a laser to outside of the electronic device through the projector.

6. The electronic device of claim 1, wherein the pattern information includes pattern information for controlling at least one of a movement of the one or more external electronic devices and a state of the one or more external electronic devices

7. The electronic device of claim 6, wherein the processor is further configured to identify a reference point for controlling the movement of the one or more external electronic devices.

8. An electronic device comprising:
an input device; and
a processor configured to:
obtain pattern information corresponding to control information for the electronic device using the input device, and
control the electronic device based on the pattern information.

9. The electronic device of claim 8, wherein the processor is further configured to identify whether the pattern information is for movement control or state control.

10. The electronic device of claim 9, wherein the processor is configured to:
if the pattern information is for the movement control, identify a reference point that is contained in the pattern information;
control the movement based on the reference point according to whether the movement is made in a direction facing the electronic device that provides the identified pattern information; and
control the movement according to the pattern information.

11. The electronic device of claim 9, wherein the processor is further configured to control the state according to the pattern information if the pattern information is for the state control.

12. An operating method of an electronic device that includes an output device and a processor, the method comprising:
creating pattern information corresponding to control information for one or more external electronic devices; and
providing the pattern information to outside of the electronic device using the output device to control the one or more external electronic devices.

13. The method of claim 12, wherein creating the pattern information comprises creating the pattern information based on at least one pattern type of numbers, figures, characters, colors, and a specified encryption scheme.

14. The method of claim 13, further comprising providing the pattern information to the one or more external electronic devices when the one or more external electronic devices are connected.

15. The method of claim 12, wherein the output device comprises a communication module, and
providing the pattern information to outside of the electronic device comprises transmitting the pattern information to the one or more external electronic devices through the communication module.

16. The method of claim 12, wherein the output device comprises a projector, and
providing the pattern information to outside of the electronic device comprises displaying the pattern information as a light from a beam or a laser to outside of the electronic device through the projector.

17. The method of claim 12, wherein creating the pattern information comprises creating pattern information for controlling at least one of a movement of the one or more external electronic devices and a state of the one or more external electronic devices.

18. The method of claim 17, wherein creating the pattern information comprises identifying a reference point for controlling the movement of the one or more external electronic devices.
